(19) United States
(12) Patent Application Publication
(10) Pub. No.: US 2013/0280676 A1
(43) Pub. Date: Oct. 24, 2013

(54) WIDE IMPLANT

(71) Applicant: ZVI LASTER, Poriya Elite (IL)

(72) Inventor: ZVI LASTER, Poriya Elite (IL)

(21) Appl. No.: 13/623,192

(22) Filed: Sep. 20, 2012

Related U.S. Application Data
(60) Provisional application No. 61/628,812, filed on Nov. 7, 2011.

(51) Int. Cl. A61C 8/00

(52) U.S. Cl. 433/174

(57) ABSTRACT

A wide implant may be provided with at least one thread comprising a distal wrap, an apical wrap, and an at least one interim wrap. The distal and the apical wraps are provided with a distal and an apical maximal radial extent Ed, Ea, respectively, greater than an interim maximal radial extent Ei pro-vided with the at least one interim wrap.

### CROSS-REFERENCE TO RELATED APPLICATIONS

This application claims priority to U.S. Provisional Patent Application Ser. No. 61/628,812 filed on Nov. 7, 2011, incorporated herein by reference in its entirety.

### FIELD OF THE INVENTION

Disclosed is a wide implant, which, by way of example only, may be applied to a bone, which may further receive a bolt, a screw, or any other applicable attachment thereto, and which is intended to provide enhanced stability and holding ability in the bone.

### BACKGROUND OF THE INVENTION

Generally, implants are adapted to be used during an implant procedure. Generally, during implant procedures, a crater may be formed that may initially be filled with congealing blood and bone fragments. The crater may generally have a substantially frusto-conical-like approximate shape.

As may be customary, implant procedures may take place immediately or relatively soon after the crater is formed during the implant procedure. Thus, the implant may be only partially lodged in solid bone, with a considerable portion thereof extending substantially unsupported out from the crater, leaving the implant to be disposed subsetantially as a cantilevered structure. Such a mode of operation may compromise the implant stability, as is well known in the art, and as may be measured as an ISQ (see http://en.wikipedia.org/wiki/Implant_stability_quotient, incorporated herein by reference). Improved implant stability may enhance osseointegration (http://en.wikipedia.org/wiki/Osseointegration, incorporated herein by reference). Such a requirement for stability is greatly desired, particularly if immediate loading is performed subsequent to the implant procedure.

FR2645011 to Serban, Florian, entitled “Bone Implant Eyebolt Which Is Intended On The One Hand To Form An Artificial Tooth Root And On The Other Hand To Reduce Bone Fractures, And Which Can Be Used In Ear, Nose And Throat Treatment” (See FIG. 1, annotated ‘Prior Art’) discloses, inter alia, (a) “Device for fixing an implant eyebolt to the bone in order to hold in position a tooth prosthesis, a hearing aid, and to reduce bone fractures.” It consists of a cylinder 1 made of metal of the “Pure titanium for medical use” type, “is provided in its upper part with a flat-headed screw 4 having a slot 5 so that it can be maneuvered by a screwdriver, and is provided in its lower part with two cylindrical pins 2 for locking the implant to bone. Prior to the positioning of this implant eyebolt, a bore is drilled with a bone-drill burr of the dimension of the eyebolt with a stop, a grinding burr with stop for the lateral and circular grinding/burring of the lower part 9, and a bone fissure burr with a stop for burring two small lateral walls. The device makes it possible to hold in position, by means of implant 12, a tooth prosthesis, a hearing aid, and to reduce bone fractures by locking the implant eyebolt to the bone, and the device permits osseointegration in the parts left empty by the burring and grinding.”

US2006110707 to Perez, Davidi Michael and Levy, Haim, entitled “Dental Implant” (see FIG. 2, annotated ‘Prior Art’), discloses, inter alia, “ . . . a rounded, mill-like member having an external diameter d1 centered in said implant's main axis and coaxial with a secondary (horizontal) axis located in a right angle with said implant's main axis, said mill-like member is characterized by a jagged milling surface in the distal end thereof facing the jawbone; an abutment located in the proximal end and exceeding from said mill-like member towards the oral cavity; wherein said drill-like member is adapted to penetrate perpendicularly to a depth of about 1 as to accommodate an intra-bony portion of the jawbone, while the mill-like member is fixated in a diameter d1 to a supra-bony portion of the jawbone.”

“Surprisingly, the dental implant according to the present invention is endowed with an improved durability to the forces generated during oral activity such as mastication or the like, and is resistant against perpendicular forces as well as lateral forces, yet the insertion thereof into a patient's jawbone is performed in a single-step operation, and does not require cutting a second incision or more in the patient's mouth, thus combining the advantages of vertical penetrating implants, that is, short treatment and healing process, and lesser risks of infection, with the strength and longwithstanding of laterally inserted implants, achieved due to the efficient fastening mechanism provided, securing in place the implant to the bone.”

DE4142584 to Lang, Manfred, titled “Dental Implant For Retaining False Tooth—Has Sickle Shaped Ribs With Sharp Edges Arranged In Helix” (see FIG. 3, annotated ‘Prior Art’), discloses “The dental implant, for retaining a false tooth, has a cylindrical upper part (2) and a tapered lower part (1). The lower part has a number of sickle shaped ribs (3) which project radially outwards. The ribs are positioned so that they lie on a helix which winds around the tapered lower part. When the implant is inserted in the alveolus in the patient's jaw, these ribs cut into the walls of the alveolus and hold the implant in place. The upper part of the implant has a tapped hole to receive the screwed shank of the false tooth. USE/ADVANTAGE—The implant for retaining a false tooth need not be inserted to the full depth of the alveolus.”

It would be desirable to have a wide implant that, when attempting to pull and/or dislodge it, will tend to resist such forces. Furthermore, it would be desirable to enhance an implant stability, as may be measured as an ISQ (see http://en.wikipedia.org/wiki/Implant_stability_quotient, incorporated herein by reference). Therefore, there currently exists a need in the industry for an implant and associated method that may tend to enhance stability, and which may tend to resist bending moments and pulling or extraction forces applied thereto. This may be attained with the subject matter in accordance with this disclosure.

### SUMMARY OF THE INVENTION

In the following disclosure, aspects thereof are described and illustrated in conjunction with systems and methods which are meant to be exemplary and illustrative, not limiting in scope.

The present invention is broadly related to an implant designed for implantation, and more specifically in human and/or animal tissue, and to a method associated with the aforementioned implant. With respect to the implant, it may comprise an implant body, which may be generally shaped as a self-tapping screw, and may be capable of tapping into bone tissues during an implant procedure, and which is also capable of resisting, or tending to resist, sideways forces and/or bending moments, after the implant has set, that is, after osseointegration. A core component of the implant may be at least one thread comprising a distal wrap, an apical wrap, and an at least one interim wrap. The distal and the apical wraps may be provided with a distal and an apical maximal radial extent Ed, Ea, respectively, greater than an interim maximal radial extent Ei provided with the at least one interim wrap.

Optionally, the apical wrap may extend away from the apical leading end in the threading-in direction Ti so as to diminish in the apical radial extent thereof, and may merge with the interim wrap.

Alternatively, the distal wrap may extend away from the distal leading end in a direction counter to the threading-in direction Ti so as to diminish in the distal radial extent thereof, and may merge with the interim wrap.

Further optionally, the distal wrap may extend away from the distal leading end in a direction counter to the threading-in direction Ti so as to diminish in the distal radial extent thereof, and may merge with the implant body.

Further optionally, the apical wrap may extend away from the apical leading end in the threading-in direction Ti so as to diminish in the apical radial extent thereof, and may merge with the implant body.

Possibly, each one of the distal, apical, and the at least one interim wraps projects generally radially away from the distal, apical, and the at least one interim root thereof, respectively, towards the distal, apical and at least one interim wrap tips, respectively.

Furthermore, each one of the distal and apical, wrap tips may be sharp.

Moreover, the at least one interim wrap tip may be blunt.

With respect to the associated method, the steps which may be carried out may involve providing a wide implant comprising an implant body having a longitudinal axis L extending between apical and distal ends; providing the implant body with at least one thread comprising a distal wrap, an apical wrap, and at least one interim wrap; providing the distal and apical wraps with a distal and an apical maximal radial extent Ed, Ea, respectively, greater than an interim maximal radial extent Ei provided to the interim wrap, so that as the wide implant is introduced into the implant site, the apical end of the implant body is inserted into the crater, having crater walls, until the apical end abuts the crater bottom while the apical and distal wraps penetrate the crater wall such that the wide implant is lodged within the implant site.

In addition to the exemplary aspects and embodiments described above, further aspects and embodiments will become apparent by reference to the drawing figures and the following detailed description.

### BRIEF DESCRIPTION OF THE DRAWINGS

Exemplary and/or illustrative embodiments of the present invention will be presented herein below in the following figures, by way of example only. The figures are not necessarily to scale, and some features may be exaggerated or minimized and/or roughly shown and/or omitted entirely, to show details of particular components, in a purpose that the present invention may become more fully understood from the detailed description and the accompanying schematic figures, wherein:

FIG. 1 is taken from the prior art reference FR2645011 showing FIG. 2A there;

FIG. 2 is taken from the prior art reference DE4142584 showing FIG. 1 there;

FIG. 3 is taken from the prior-art reference US2006110707 showing FIG. 9 there;

FIG. 4 is a schematic top perspective view of one embodiment of a wide implant, showing the distal end at the top right end of the drawing;

FIG. 5 is a schematic bottom perspective view of the embodiment of the wide implant as exemplarily illustrated in FIG. 4, showing the apical end at the bottom left end of the drawing;

FIG. 6 is a schematic plan view of the distal end of the embodiment of the wide implant as exemplary illustrated in FIG. 4;

FIG. 7 is a schematic plan view of the apical end of the embodiment of the wide implant as exemplary illustrated in FIG. 4;

FIG. 8a-8d are four schematic elevation views of the embodiment of the wide implant as exemplary illustrated in FIG. 4 from four different quadrants; and

FIG. 9 is a schematic, longitudinal cross-sectional view of the embodiment of the wide implant schematically illustrated in FIG. 4.

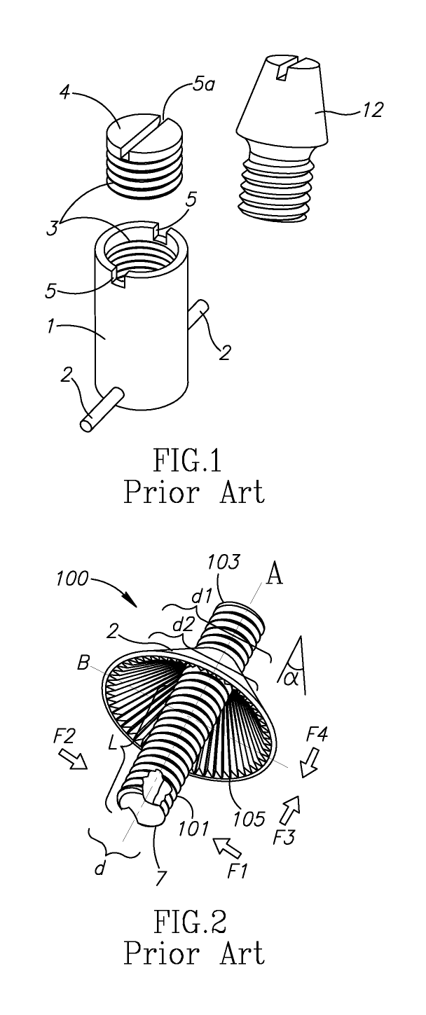

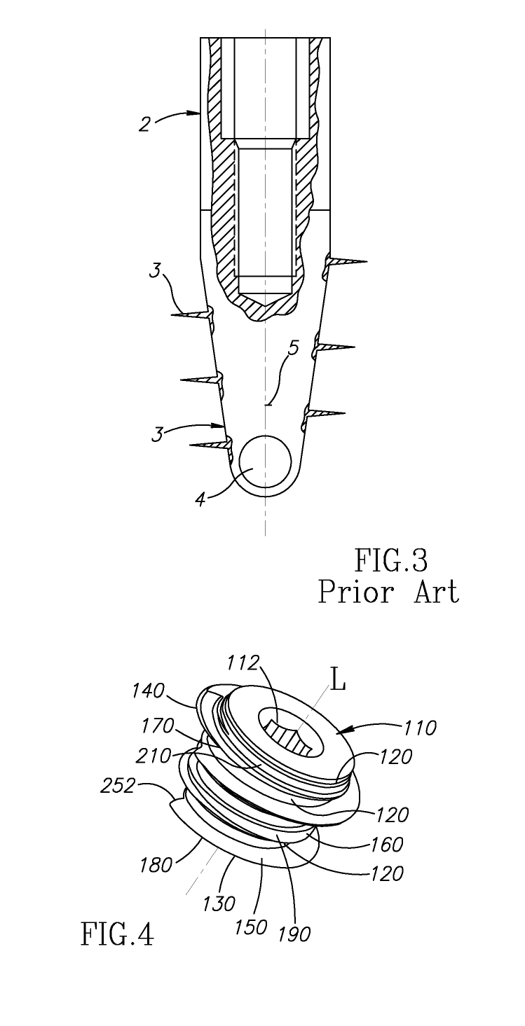

### DETAILED DESCRIPTION OF THE PREFERRED EMBODIMENT

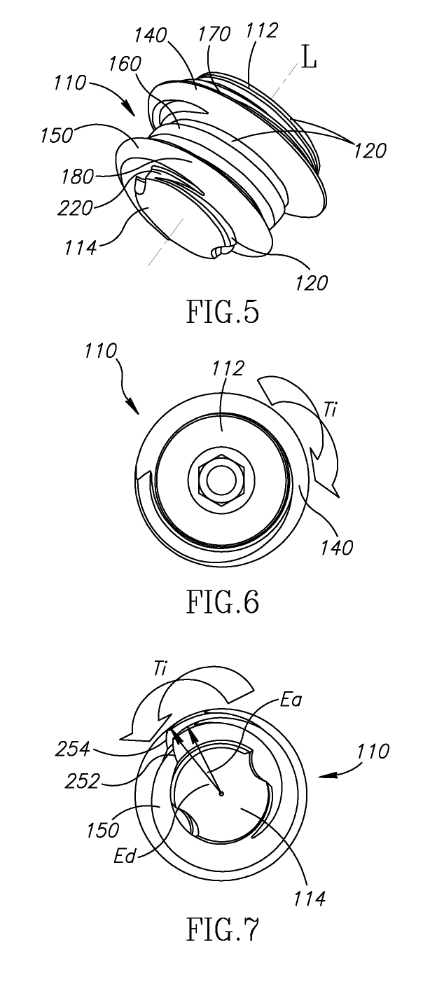

Attention is drawn to FIGS. 4 and 5. A wide implant 110 is adapted to be implanted into and/or onto a substrate (not shown). For illustrative purposes only, such substrates may include, but are not limited to, bone or osseous tissues (see http://en.wikipedia.org/wiki/Bone_tissue, http://en.wikipedia.org/wiki/Osseous_tissue, incorporated herein by reference). The wide implant 110 comprises an implant body 120 which may have any generally cylindrical and/or conical and/or frusto-conical and/or stepped frusto-conical shape. The wide implant 110 extends from a distal end 112 (seen on FIGS. 4 and 5 on a top right of the illustration) to an apical end 114 (seen on FIGS. 4 and 5 on a bottom left of the illustration) along a longitudinal axis L.

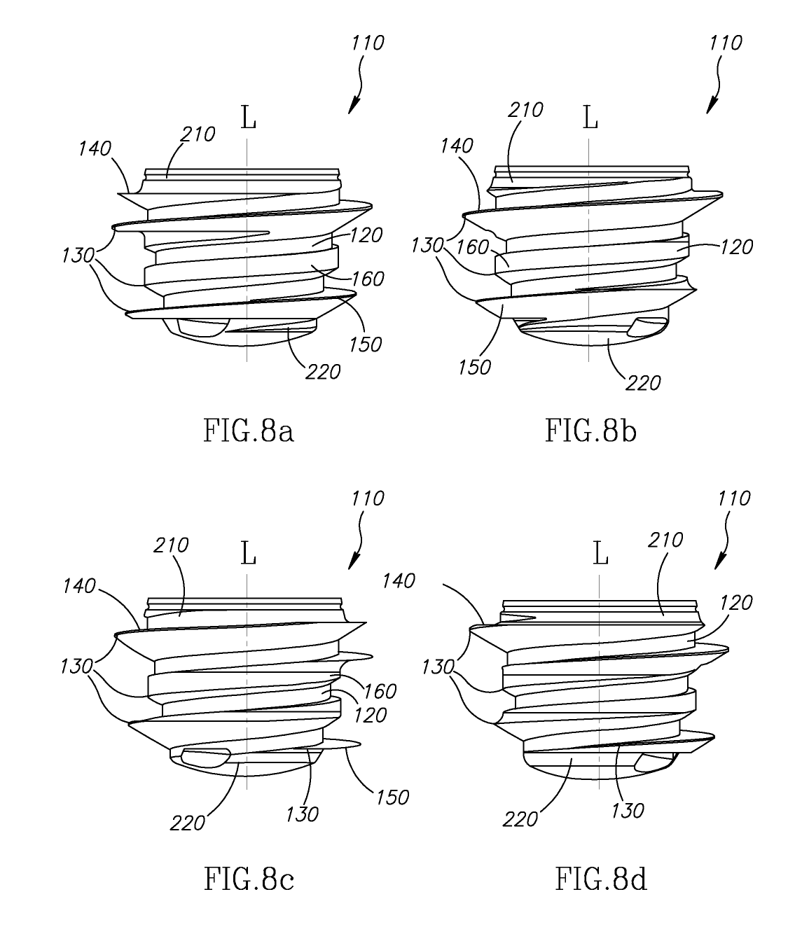

As may be best noted additionally on FIGS. 6, 7, 8a-8d, and 9, the implant body 120 comprises a base 210 adjacent to the distal end 112 and extending generally longitudinally away therefrom towards a crown 220 adjacent to the apical end 114 and terminating therewith. At least one thread 130 may helically extend about the implant body 120 away from the crown 220 towards the base 210 defining a threading-in direction Tᵢ. The at least one thread 130 may be integrally formed with the implant body 120 and may comprise a distal flank 132 generally facing towards the distal end 112 of the wide implant 110, an apical flank 134 generally facing towards the apical end 114 of the wide implant 110, and a tip 136 terminating the distal and apical flanks 132, 134, and connecting the same together.

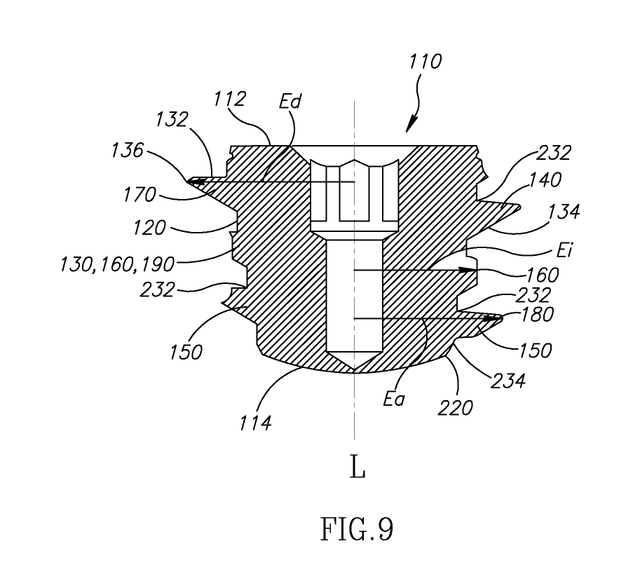

Each of the distal and apical flanks 132, 134 meets the implant body 120 at a distal and an apical root 232, 234, respectively (may best be seen on FIG. 9). The at least one thread 130 of the wide implant 110 may comprise a distal wrap 140, an apical wrap 150, and at least one interim wrap 160. The distal, apical, and the at least one interim wraps 140, 150, 160, may be continuous. However, in other embodiments (not shown) there may be a first thread comprising a distal wrap and a second thread comprising an apical wrap, wherein the first thread and/or the second thread may further comprise an interim wrap or a plurality of interim wraps extending therefrom and merging therewith. Each one of the distal, apical, and the at least one interim wraps 140, 150, 160 may project generally radially away from the distal root 232 thereof, respectively, towards a distal, apical and at least one interim wrap tips 170, 180, 190, respectively, to a distal, an apical, and an interim maximal radial extent E_{d}, Eₐ, Eᵢ respectively. The interim maximal radial extent E, is smaller than either the distal and/or apical radial extents E_{d}, Eₐ. Referring again to FIG. 9, each one of the distal and apical wrap tips 170, 180 may be sharp, while the interim wrap tip 190 may be rather blunt.

Attention is directed again to FIGS. 4 and 5. An apical leading end 254 (see FIG. 7) of the apical wrap 180 may extend generally radially away from the implant body 120 adjacent the crown 220. The apical wrap 150 extends away from the apical leading end 114 in a direction counter to the threading-in direction Tᵢ so as to gradually diminish in the radial extent thereof and to merge with the interim wrap 160. The interim wrap 160 continues to extend away in a direction counter to the threading-in direction Tᵢ so as to meet and/or merge with a distal leading end 252 extending generally radially away from the implant body 120. The distal wrap 140 extends away from the distal leading end 112 in the direction of the threading-in direction Tᵢ so as to gradually diminish in the radial extent thereof so as to merge with the base 210. However, in other embodiments (not shown) one of the first thread comprising the distal wrap and/or the second thread comprising the apical wrap may gradually diminish in the radial extent thereof so as to merge with the interim wrap or a plurality of interim wraps extending therefrom and merging therewith, while the other of the first thread comprising the distal wrap and/or the second thread comprising the apical wrap may gradually diminish in the radial extent thereof so as to merge with the implant body 120.

As the wide implant 110 is introduced into an implant site (not shown on any of the drawings), the apical end 114 of the implant body 120 and the crown 220 thereof may be inserted into a crater having crater walls (not shown on any of the drawings). When the wide implant 110 is inserted into the implant site (not shown on any of the drawings), the apical flank 134 of at least an apical leading end 114 of the apical wrap 180 may abut and/or penetrate a crater wall (not shown on any of the drawings). As the wide implant 110 is threaded into the crater (not shown on any of the drawings) in the threading-in direction Ti, the apical leading end 114 may penetrate the crater walls (not shown on any of the drawings). Insertion of the wide implant 110 may proceed in the threading-in direction Ti until the apical end 114 abuts the crater bottom (not shown on any of the drawings). As insertion proceeds, the sharp-tipped distal wrap 140 may also penetrate the crater wall (not shown on any of the drawings) such that the wide implant 110 may be lodged in the implant site and help seal the crater against foreign matter and/or infections, to enhance the stability of the wide implant 110 within the crater (not shown on any of the drawings), and may assist in preventing unwanted extraction of the wide implant 110 from the implant site (not shown on any of the drawings).

All directional references (such as, but not limited to, upper, lower, upward, downward, left, right, leftward, rightward, top, bottom, above, below, vertical, horizontal, clockwise, and counter-clockwise, tangential, axial and/or radial, or any other directional and/or similar references) are only used for identification purposes to aid the reader's understanding of the embodiments of the present disclosure, and may not create any limitations, particularly as to the position, orientation, or use unless specifically set forth in the claims. Similarly, joinder references (such as, but not limited to, attached, coupled, connect, accommodate and the like and their derivatives) are to be construed broadly and may include intermediate members between a connection of elements and relative movement between elements. As such, joinder references may not necessarily infer that two elements are directly connected and in fixed relation to each other.

In some instances, components are described with reference to “ends” having a particular characteristic and/or being connected with another part. However, those skilled in the art will recognize that the present disclosure is not limited to components which terminate immediately beyond their points of connection with other parts. Thus, the term “end” should be interpreted broadly, in a manner that includes areas adjacent, rearward, forward of, or otherwise near the terminus of a particular element, link, component, part, member or the like. Additionally, all numerical terms, such as, but not limited to, “first”, “second”, “third”, or any other ordinary and/or numerical terms, should also be taken only as identifiers, to assist the reader's understanding of the various embodiments, variations and/or modifications of the present disclosure, and may not create any limitations, particularly as to the order, or preference, of any embodiment, variation and/or modification relative to, or over, another embodiment, variation and/or modification.

In methodologies directly or indirectly set forth herein, various steps and operations are described in one possible order of operation, but those skilled in the art will recognize that steps and operations may be rearranged, replaced, or eliminated without necessarily departing from the spirit and scope of the present disclosure as set forth in the claims. It is intended that all matter contained in the above description or shown in the accompanying drawings shall be interpreted as illustrative only and not limiting. Changes in detail or structure may be made without departing from the spirit of the present disclosure as defined in the appended claims.

While an exemplary embodiment has been described and shown in the accompanying drawings, it is to be understood that such an embodiment is merely illustrative of and not restrictive on the broad present disclosure, and that this disclosure may not be limited to the specific constructions and arrangements shown and described, since various other modifications and/or adaptations may occur to those of ordinary skill in the art. It is to be understood that individual features shown or described for the exemplary embodiment in the context of functional elements and such features may be replicated, or be omitted within the scope of the present disclosure and without departing from the spirit of the present disclosure as may be defined in the appended claims.

1. A wide implant having a longitudinal axis L and comprising an threaded implant body extending generally longitudinally between a distal end and an apical end, the threaded implant body being provided with a distal wrap disposed generally adjacent the distal end, an apical wrap disposed generally adjacent the apical end, and at least one interim wrap disposed substantially therebetween, wherein the distal and the apical wraps are provided with a distal and an apical maximal radial extent Ed, Ea, respectively, greater than an interim maximal radial extent Ei provided with the at least one interim wrap.

2. The wide implant of claim 1, wherein the apical wrap extends away from an apical leading end in a direction of the threading-in direction Ti so as to diminish in a apical radial extent thereof and to merge with the interim wrap.

3. The wide implant of claim 1, wherein the distal wrap extends away from a distal leading end in a direction counter to the threading-in direction Ti so as to diminish in a distal radial extent thereof and to merge with the interim wrap.

4. The wide implant of claim 2, wherein the distal wrap extends away from an distal leading end in a direction counter to the threading-in direction Ti so as to diminish in a distal radial extent thereof and to merge with the implant body.

5. The wide implant of claim 3, wherein the apical wrap extends away from an apical leading end in a direction of the threading-in direction Ti so as to diminish in a apical radial extent thereof and to merge with the implant body.

6. The wide implant of claim 1, wherein each of the distal, apical, and the at least one interim wraps projects generally radially away from a distal, apical, and the at least one interim root thereof, respectively, towards a distal, apical and at least one interim wrap tips, respectively.

7. The wide implant of claim 6, wherein each of the distal and apical, wrap tips is sharp.

8. The wide implant of claim 6, wherein the at least one interim wrap tip is blunt.
